(19) United States
(12) Patent Application Publication
(10) Pub. No.: US 2026/0278988 A1
(43) Pub. Date: Sep. 17, 2026

(54) GRAPH CUTS FOR VIDEO OBJECT CENTRIC REPRESENTATION LEARNING

(71) Applicant: QUALCOMM Technologies, Inc., San Diego, CA (US)

(72) Inventors: Adeel Ahsan PERVEZ, Klosterneuburg (AT); Phillip LIPPE, Amsterdam (NL); Efstratios GAVVES, Amsterdam (NL)

(21) Appl. No.: 19/472,073

(22) PCT Filed: May 15, 2024
(86) PCT No.: PCT/US2024/029493

§ 371 Date: Oct. 2, 2025

(30) Foreign Application Priority Data
May 26, 2023 (GR) 20230100422

(51) Int. Cl. G06V 10/20; G06T 7/246

(52) U.S. Cl. CPC G06V 10/255; G06T 7/248

(57) ABSTRACT

Techniques and systems are provided for image processing. For instance, a process can include obtaining, from one or more image sensors, a first image and a second image; determining local motion between the first image and the second image for features of the first image and the second image; generating motion vectors based on the local motion; and identifying an object based on the motion vectors.

### FIELD

This application is related to object centric learning. For example, aspects of the application relate to systems and techniques for graph cuts for video object centric representation learning.

### BACKGROUND

Many devices and systems allow video data to be processed and output for consumption. Digital video data includes large amounts of data to meet the demands of consumers and video providers. For example, consumers of video data desire high quality video, including high fidelity, resolutions, frame rates, and the like. As a result, the large amount of video data that is required to meet these demands places a burden on communication networks and devices that process and store the video data.

Machine learning (ML) techniques may have numerous applications in image-based processing of videos or video streams such as human pose estimation, object detection, semantic segmentation, as well as video compression and denoising. Unfortunately, such video processing is computationally intensive which results in significant time and energy consumption.

### SUMMARY

Systems and techniques are described herein for protecting against malicious attacks in images. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, a method for image processing is provided. The method includes: obtaining, from one or more image sensors, a first image and a second image; determining local motion between the first image and the second image for features of the first image and the second image; generating motion vectors based on the local motion; and identifying an object based on the motion vectors.

As another example, an apparatus for image processing is provided. The apparatus includes at least one memory and at least one processor coupled to the at least one memory. The at least one processor is configured to: obtain, from one or more image sensors, a first image and a second image; determine local motion between the first image and the second image for features of the first image and the second image; generate motion vectors based on the local motion; and identify an object based on the motion vectors.

In another example, a non-transitory computer-readable medium having stored thereon instructions is provided. The instructions, when executed by at least one processor, cause the at least one processor to: obtain, from one or more image sensors, a first image and a second image; determine local motion between the first image and the second image for features of the first image and the second image; generate motion vectors based on the local motion; and identify an object based on the motion vectors.

As another example, an apparatus for image processing is provided. The apparatus includes: means for obtaining, from one or more image sensors, a first image and a second image; means for determining local motion between the first image and the second image for features of the first image and the second image; means for generating motion vectors based on the local motion; and means for identifying an object based on the motion vectors.

In some aspects, one or more of the apparatuses described herein can include or be part of an extended reality device (e.g., a virtual reality (VR) device, an augmented reality (AR) device, or a mixed reality (MR) device), a mobile device (e.g., a mobile telephone or other mobile device), a vehicle or a computing system or device of the vehicle, a wearable device (e.g., a network-connected watch or other wearable device), a personal computer, a laptop computer, a server computer, a television, a video game console, or other device. In some aspects, the apparatus further includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit data or information over a transmission medium to at least one device. In some aspects, the processor includes a central processing unit (CPU), a graphics processing unit (GPU), a neural processing unit (NPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and

processing system, in accordance with aspects of the present disclosure.

FIGS. 2A-FIG. 2D and FIG. 3 are diagrams illustrating examples of neural networks, in accordance with some examples.

FIG. 4 is a block diagram illustrating a structure for a set of machine-learning (ML) networks for performing graph cuts, in accordance with aspects of the present disclosure.

FIG. 5 is a diagram illustrating a graph cut problem for a graph, in accordance with aspects of the present disclosure.

FIG. 6 is a diagram illustrating generation of a graph for encoding local motion information, in accordance with aspects of the present disclosure.

FIG. 7 is a diagram illustrates an example of motion vector generation, in accordance with aspects of the present disclosure.

FIG. 8 is a flow diagram illustrating a process for image processing, in accordance with aspects of the present disclosure.

FIG. 9 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

In some cases, one or more sensors (e.g., image sensors, such as a camera, range sensors such as radar and/or light detection and ranging (LIDAR) sensors, etc.) of a device or system may be used to obtain information about an environment in which the device or system is located. A processing system of the device or system may be used to process the information for one or more operations, such as route planning, navigation, collision avoidance, among others. For example, in some cases, the sensor data may be obtained from the one or more sensor (e.g., one or more images captured from one or more cameras, depth information captured or determined by one or more radar and/or LIDAR sensors, etc.), transformed, and analyzed to detect objects.

As an example, an image may be analyzed to semantically segment a view (e.g., image, video, etc.) of an environment. While there are existing techniques for semantically segmenting or otherwise processing an image, there is a desire to improve upon these techniques, for example to reduce processing and/or power consumption. Traditional machine learning (ML) techniques for image processing focus on an image as a whole to detect features in an image and associate the detected features with each other to recognize objects. Object-centric representation techniques for ML models, such as convolution neural networks (CNNs) differ from traditional ML techniques as object-centric representations learn an internal representation of objects. As an example, an ML using object-centric representations may learn to partition features into per-object representations of the object and generate an image of the representation of the object. Expanding on this technique for learning an internal representation of objects, in some cases, it may be useful for an ML model to learn an internal representation of a motion of the objects.

Systems, apparatuses, electronic devices, methods (also referred to as processes), and computer-readable media (collectively referred to herein as “systems and techniques”) are described herein for generating a graph of motion vectors based on images from a video and using graph cuts to identify edges for objects in the video. The systems can include an XR system, a vehicle (or a computing system or device of the vehicle), an unmanned aerial vehicle, and/or other type of system. In some aspects, it may be useful for an ML model to have an internal representation of motion. This internal representation of motion may be used to identify edges of objects.

As an example, a graph of motion vectors may be generated based on an image-to-image local motion of features (e.g., pixels or features of the images detected by feature detectors). The graph may then be cut based in part on where the motion vectors differ. Locations where the motion vectors differ may indicate an edge between different objects. In some cases, a location for these cuts may be determined based on a set of linear equations. These linear equations may be differentiable, allowing for a loss function to be determined based on the linear equations. This loss function may be used for generating feedback to train the ML model.

In some cases, an object centric representation that has an internal representation of motion may allow for better detection of objects based on identifying edges of objects through a change in motion. Additionally, this internal representation of object motion may allow, for example, improved tracking of moving objects, along with improved predictions of how an object may move in the future.

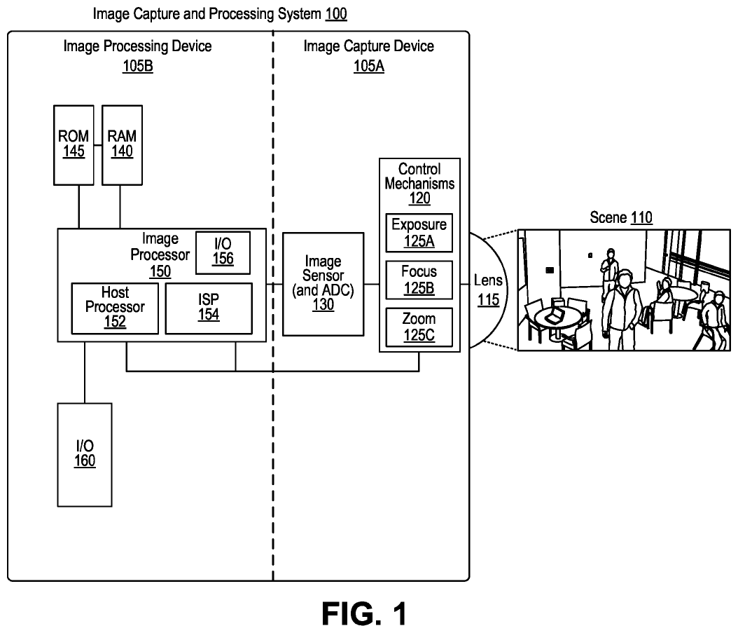

Various aspects of the application will be described with respect to the figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

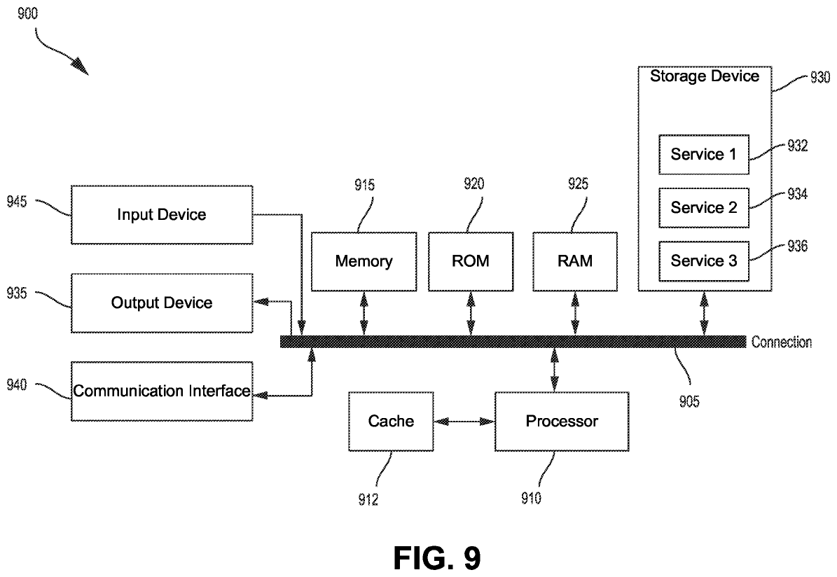

The image processor 150 may include one or more processors, such as one or more image signal processors (ISPs) (including ISP 154), one or more host processors (including host processor 152), and/or one or more of any other type of processor 910 discussed with respect to the computing system 900 of FIG. 9. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140, read-only memory (ROM) 145, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

In some cases, images captured by the image capture and processing system 100 may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

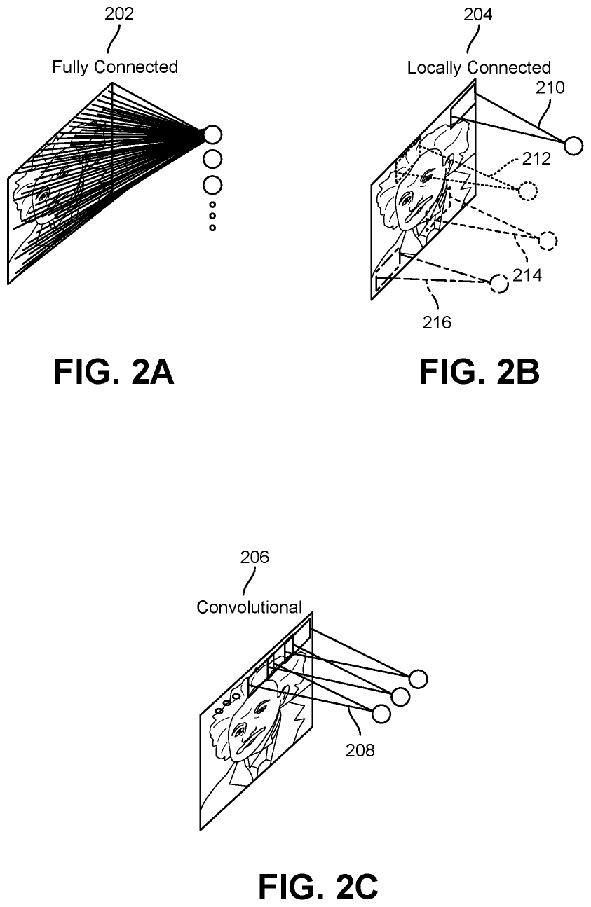

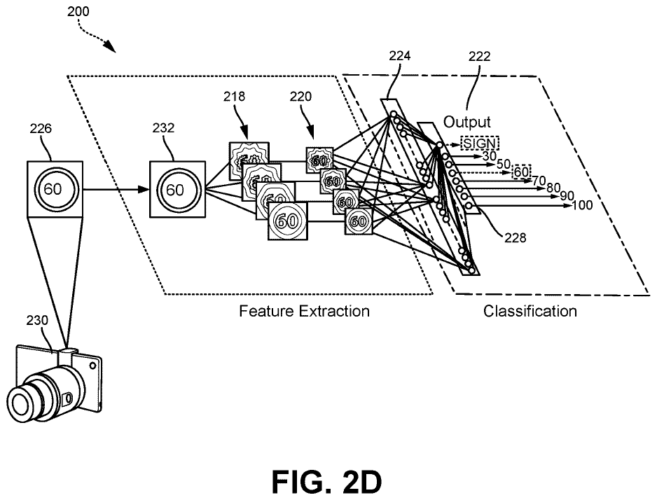

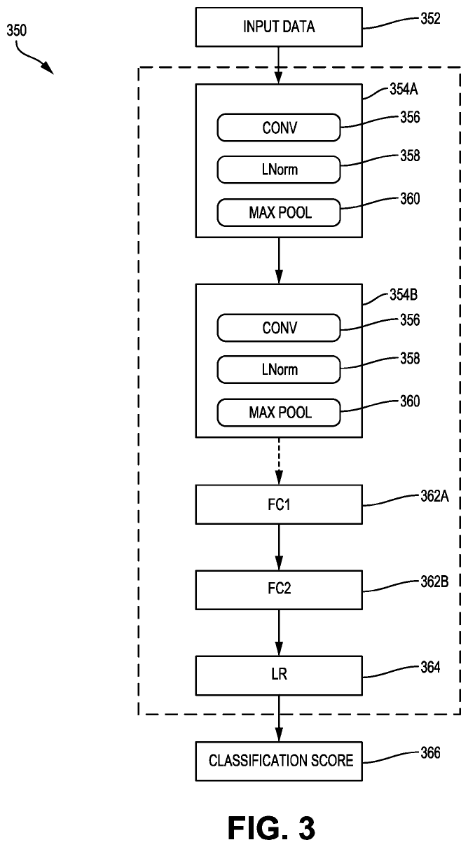

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as a image capture and processing system 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer.

In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a processor such as a CPU or GPU, or any other type of processor 910 discussed with respect to the computing system 900 of FIG. 9 to achieve high performance and low power consumption. In alternative aspects, the parallel filter banks may be loaded on a DSP or an ISP of the computing system 900 of FIG. 9. In addition, the deep convolutional network 350 may access other processing blocks that may be present on the computing system 900 of FIG. 9, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, an ML model, such as a neural network, convolutional neural network, etc., may be configured (e.g., trained to perform) for object-centric representation. Instead of training the ML model to identify or recognize an object in a picture or video, in object-centric representation, the model may be trained to learn an internal representation of objects in the picture or video. The ML model with object-centric representation may learn to partition features into per-object representations of the object. For example, the ML model with object-centric representation may be able to reconstruct an object (e.g., of K objects) and generate an image of the reconstructed object (e.g., with or without the other K−1 objects) for output. These representations may then be used for additional tasks, such as semantic segmentation, recognition, etc.

In some cases, the ML model with object-centric representation may also learn a representation of a motion of the object in a video, for example to output a motion track, motion vector, or other representation of the motion of an object. For example, a ML model, such as a neural network, with object-centric representation may construct a series of nodes which may represent pixels (or features) of a video where connections between pixels may represent weights between the pixels. The weights may represent how correlated the movement is as between the pixels or how related the pixels are. These nodes and weights together may form a weighted graph. In some cases, graph cuts may be used to partition the graph into components (e.g., representations of objects in the video).

In some cases, to allow an ML model to learn an object-centric representation of an object and motion of the object, the ML model may include differentiable cut modules. Differentiable cut modules may determine graph cuts for the ML model. In some cases, graph cut methods may be incorporated in neural networks using linear programming formulations or specialized algorithms.

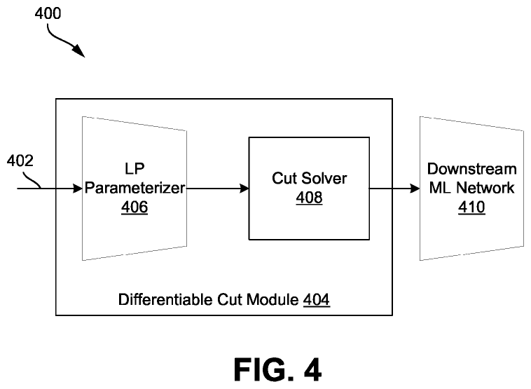

FIG. 4 is a block diagram 400 illustrating a structure for a set of ML networks for performing graph cuts, in accordance with aspects of the present disclosure. As shown in FIG. 4, a graph (e.g., generated from previous images of a video) may be input 402 to a differentiable cut module 404. The differentiable cut module 404 may include a linear program (e.g., a set of linear equations) paramaterizer 406, which may solve a series of linear equations for weights of the graph. Based on the solutions to the linear equations, the graph may be cut by the cut solver 408 and a cut graph may be output for processing by downstream ML networks 410.

In some cases, graph cuts may be applied in per-instance post-hoc explainability for images using, for example, a learning to explain framework. That is, given a classification network, a second network may be configured to take a segment of the input and aims to match the predictions of the classifier. In other words, the second network attempts to determine a subset of the input that is important in generating the prediction output of the classification network. The second network may be referred to as an explainer network, and may generate a mask specifying which segment of the input to pass to the classification network.

In some cases, the explainer network may use graph cuts to output, for example, the parameters of a graph minimum-cut problem considering the image as a graph. Solving the minimum-cut problem may provide a partition of the pixels. The negative pixels may be masked in the image and the positive pixels (e.g., objects) may be supplied to a downstream network.

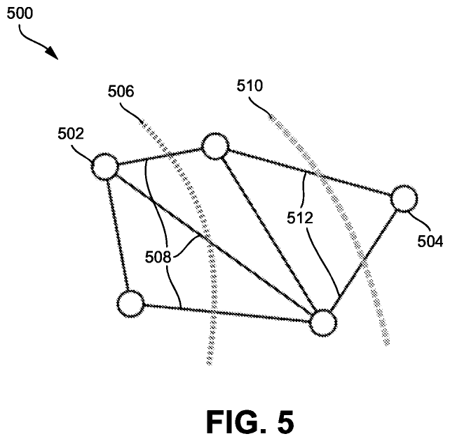

FIG. 5 is a diagram illustrating a graph cut problem for a graph 500, in accordance with aspects of the present disclosure. In FIG. 5, the graph cut problem illustrated is a minimum source-terminal cut problem. In the minimum source-terminal (s.t.) cut problem, given a graph 500 with nodes, such as nodes 502 and 504, with weights on vertices (e.g., connections between nodes) the challenge is to partition the graph into two components such that the weight of the cross edges are minimized. For example, a first cut 506 may be associated with the weights of vertices 508 and a second cut 510 may be associated with weights of vertices 512 and the cut associated with less weight may be made.

As a more specific example, an ML model may generate graph 500 describing an input image such that the nodes 502 and 504 may represent pixels of the image and the vertices may represent relations as between pixels. The cuts may be performed when segmenting the image into constituent objects. In some cases, a solution for the s.t. cut problem as to which cuts to the graph may be made can be approximated using a set of linear equations, such as the below equations:

$$min {\sum }_{u , v} {c}_{u , v} {d}_{u , v} , \\ s . t . \\ {d}_{u , ν} \geq {p}_{u} - {p}_{ν} ∀ ( u , v ) ∈ E , \\ {p}_{s} - {p}_{u} \geq 1 , \\ {d}_{u , v} \geq 0 , ∀ ( u , v ) ∈ E , \\ {p}_{u} \geq 0 , {∀}_{u} ∈ V ,$$

where c_{u,v} represents a parameterization of weights of the graph, d_{u,v} represents locations of the cuts, ∀(u, v)∈E, and ∀ᵤ∈V represent constraints on the solution, and the equations perform a minimization over the parameterized weights.

In some cases, training an ML model to solve for the s.t. cut problem may be unsupervised (e.g., can be performed without labelled training image). For example, for an image, the ML model with object-centric representation with the s.t. cut solution may output reconstructed objects. These reconstructed objects may be put together (e.g., overlaid together over the image) and compared against the original image to determine a loss value for training. In some cases, using linear equations for the s.t. cut solution allows the solution to be differentiable so the loss function can be readily determined.

In some cases, motion information may be used to help group pixels of the image into objects for the object-centric representation. In some cases, features which encode local motion information may be used. For example, rather than features which describe a pixel or other portion of an image with respect to other portion of the image, motion features may describe how a pixel or other portion of the image (e.g., a feature) moves across video frames. A graph may be generated based on the local motion features, for example, by an ML model and this graph may be cut, for example, in a manner similar to that described above with respect to the s.t. cut problem above. The s.t. cuts may be used to transform local motion information into global clusters with similar motion. For example, portions with a similar motion may be grouped together as a single object by the s.t. cuts and cuts may be applied where the motion of different portions differ.

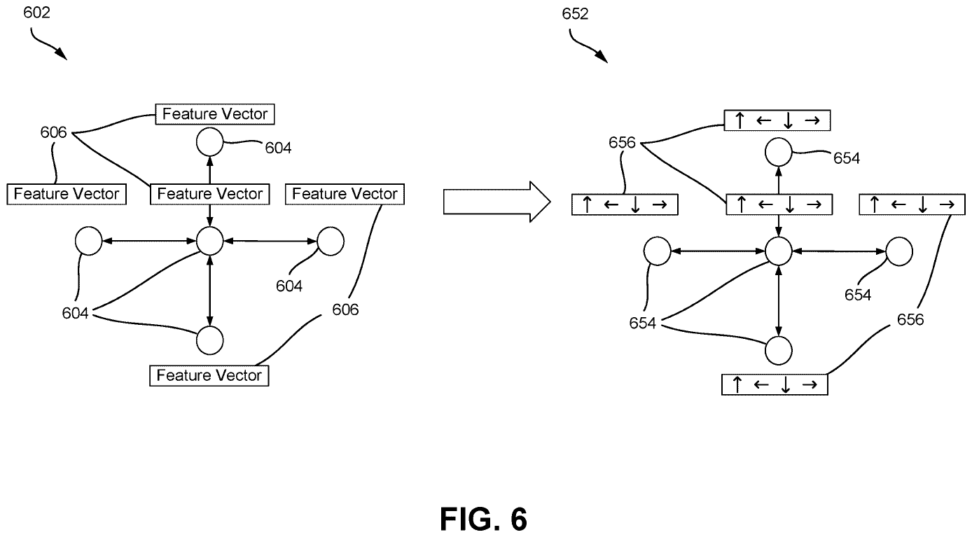

FIG. 6 is a diagram illustrating generation of a graph for encoding local motion information, in accordance with aspects of the present disclosure. Portions of two graphs are shown in FIG. 6, including a first graph 602 and a second graph 652. The first graph 602 may be generated by an ML model based on an image of a video. The first graph 602 includes nodes 604 which may represent portions of the image, such as pixels, features, and the like. For example, the nodes 604 may represent pixels or features with an associated feature vector 606 based on application of weights including features detected in the input pixels or features by feature detectors. The lines between the nodes 604 may represent weights applied to the input to generate the feature vectors 606.

In some cases, the second graph 652 may be generated based on the first graph 602 by replacing (or adding) the feature vectors 606 with motion vectors 656 (e.g., motion-encoding vectors) based on local motion incorporated into the feature vectors for the nodes 654. In some cases, motion vectors 656 may be placed in the nodes 654 of the second graph 652 along with the feature vectors 606. The motion vectors 656 may describe the motion of the feature vectors (e.g., representing pixels, previous features, etc.) as between frames of the video. Links between the nodes 654 may be represent weights describing similarities between the motion vectors 656 of adjacent nodes 654.

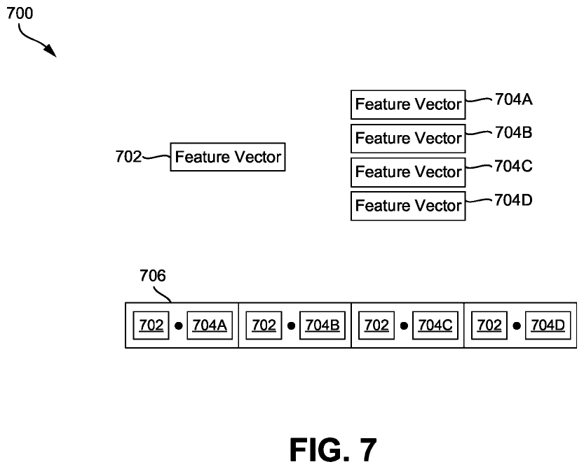

FIG. 7 is a diagram 700 illustrates an example of motion vector (e.g., local motion vector) generation, in accordance with aspects of the present disclosure. In some cases, motion vectors may be generated based on motion between frames of a video for features of the frames. For example, a first feature vector 702 may be generated for a first portion (e.g., pixel, feature, set of pixels, etc.) of a first frame (not shown). For a second frame, (not shown), feature vectors 704A-704D may be generated for the four neighbors of the first portion. For example, feature vector 704A may represent a portion of the image above the first portion, feature vector 704B may represent a portion of the image to the right the first portion, feature vector 704C may represent a portion of the image below the first portion, and feature vector 704D may represent a portion of the image to the left of the first portion 703.

A motion vector 706 for the first portion may then be generated based on how similar (or different) the first feature vector 702 is to feature vectors 704A-704D of the neighbors in the second frame. While the diagram 700 of FIG. 7 shows four neighboring portions to the first portion, it should be understood that additional neighboring portions may be included in the motion vector.

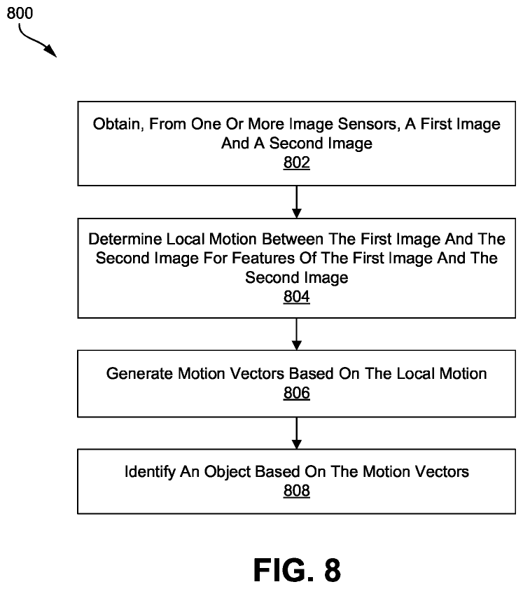

FIG. 8 is a flow diagram illustrating a process 800 for image processing, in accordance with aspects of the present disclosure. The process 800 may be performed by a computing device (or apparatus, e.g., image capture and processing system 100 of FIG. 1, computing system 900 of FIG. 9, etc.) or a component (e.g., a chipset, codec, etc.,) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., image processor 150 of FIG. 1, host processor 152 of FIG. 1, processor 910 of FIG. 9, etc.).

At block 802, the computing device (or component thereof) may obtain, from one or more image sensors (e.g., image sensor 130 of FIG. 1), a first image and a second image.

At block 804, the computing device (or component thereof) may determine local motion between the first image and the second image for features of the first image and the second image. In some cases, feature detectors which encode local motion information based on an image-to-image local motion may be used.

At block 806, the computing device (or component thereof) may generate motion vectors based on the local motion. In some cases, the computing device (or component thereof) may generate a graph of the motion vectors. For example, a graph of motion vectors may be generated based on an image-to-image local motion of features as detected by the feature detectors. In some cases, the computing device (or component thereof) may generate the graph of the motion vectors by generating a feature graph based on the features of the first image and the second image, the feature graph including nodes connected by edges, and wherein the nodes of the graph include features (e.g., as discussed with respect to FIG. 6). In some cases, the computing device (or component thereof) may further generate the graph of the motion vectors by placing motion features into nodes of the graph, wherein the motion features are based on the motion vectors. For example, the nodes may represent pixels with an associated feature vector indicating weights for features possibly detected in the pixel by feature detectors and these feature vectors may be replaced with motion vectors describing local motion for the nodes as between images. In some cases, placing motion features in the nodes of the graph comprises replacing the features of the nodes with motion features. In some cases, the motion vectors are generated based on a similarity between features of the first image and neighboring portions of the features in the second image. In some cases, features comprise one or more pixels of the first image and the second image. In some cases, the computing device (or component thereof) may determine a location of a graph cut to the graph of motion vectors based on the motion vectors. In some cases, the location of the graph cut is based on differences between the motion vectors. In some cases, the graph cut is between a source node and a terminal node of the graph. In some cases, the location of the graph cut is determined based on a set of differentiable linear equations, such as those discussed above with respect to FIG. 5.

At block 808, the computing device (or component thereof) may identify an object based on the motion vectors. In some cases, the computing device (or component thereof) may process the object to generate a prediction for output. For example, based on the motion vectors for an identified object, a prediction for a future movement of the object may be generated.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, camera, accelerometers, gyroscopes, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some examples, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the present disclosure include:

Aspect 1. A method for image processing, comprising: obtaining, from one or more image sensors, a first image and a second image; determining local motion between the first image and the second image for features of the first image and the second image; generating motion vectors based on the local motion; and identifying an object based on the motion vectors.

Aspect 2. The method of Aspect 1, further comprising processing the object to generate a prediction for output.

Aspect 3. The method of any of Aspects 1-2, further comprising: generating a graph of the motion vectors; and determining a location of a graph cut to the graph of motion vectors based on the motion vectors.

Aspect 4. The method of Aspect 3, wherein the location of the graph cut is based on differences between the motion vectors.

Aspect 5. The method of Aspect 3, wherein the graph cut is between a source node and a terminal node of the graph.

Aspect 6. The method of Aspect 3, wherein generating the graph of the motion vectors comprises: generating a feature graph based on the features the first image and the second image, the feature graph including nodes connected by edges, and wherein the nodes of the graph include features; and placing motion features into nodes of the graph, wherein the motion features are based on the motion vectors.

Aspect 7. The method of Aspect 6, wherein placing motion features in the nodes of the graph comprises replacing the features of the nodes with motion features.

Aspect 8. The method of Aspect 3, wherein the location of the graph cut is determined based on a set of differentiable linear equations.

Aspect 9. The method of any of Aspects 1-8, wherein the motion vectors are generated based on a similarity between features of the first image and neighboring portions of the features in the second image.

Aspect 10. The method of any of Aspects 1-9, wherein features comprises one or more pixels of the first image and the second image.

Aspect 11. The method of any of Aspects 1-10, wherein the method is performed by one or more convolutional neural networks.

Aspect 12. An apparatus for image processing, comprising: at least one memory; and at least one processor coupled to the at least one memory and configured to: obtain, from one or more image sensors, a first image and a second image; determine local motion between the first image and the second image for features of the first image and the second image; generate motion vectors based on the local motion; and identify an object based on the motion vectors.

Aspect 13. The apparatus of Aspect 12, wherein the at least one processor is further configured to process the object to generate a prediction for output.

Aspect 14. The apparatus of any of Aspects 12-13, wherein the at least one processor is further configured to: generate a graph of the motion vectors; and determine a location of a graph cut to the graph of motion vectors based on the motion vectors.

Aspect 15. The apparatus of Aspect 14, wherein the location of the graph cut is based on differences between the motion vectors.

Aspect 16. The apparatus of Aspect 14, wherein the graph cut is between a source node and a terminal node of the graph.

Aspect 17. The apparatus of Aspect 14, wherein, to generate the graph of the motion vectors, the at least one processor is configured to: generate a feature graph based on the features the first image and the second image, the feature graph including nodes connected by edges, and wherein the nodes of the graph include features; and place motion features into nodes of the graph, wherein the motion features are based on the motion vectors.

Aspect 18. The apparatus of Aspect 17, wherein placing motion features in the nodes of the graph comprises replacing the features of the nodes with motion features.

Aspect 19. The apparatus of Aspect 14, wherein the location of the graph cut is determined based on a set of differentiable linear equations.

Aspect 20. The apparatus of any of Aspects 12-19, wherein the motion vectors are generated based on a similarity between features of the first image and neighboring portions of the features in the second image.

Aspect 21. The apparatus of any of Aspects 12-20, wherein features comprises one or more pixels of the first image and the second image.

Aspect 22. A non-transitory computer-readable medium having stored thereon instructions that, when executed by at least one processor, cause the at least one processor to: obtain, from one or more image sensors, a first image and a second image; determine local motion between the first image and the second image for features of the first image and the second image; generate motion vectors based on the local motion; and identify an object based on the motion vectors.

Aspect 23. The non-transitory computer-readable medium of Aspect 22, wherein the instructions cause the at least one processor to process the object to generate a prediction for output.

Aspect 24. The non-transitory computer-readable medium of any of Aspects 22-23, wherein the instructions cause the at least one processor to: generate a graph of the motion vectors; and determine a location of a graph cut to the graph of motion vectors based on the motion vectors.

Aspect 25. The non-transitory computer-readable medium of Aspect 24, wherein the location of the graph cut is based on differences between the motion vectors.

Aspect 26. The non-transitory computer-readable medium of Aspect 24, wherein the graph cut is between a source node and a terminal node of the graph.

Aspect 27. The non-transitory computer-readable medium of Aspect 24, wherein, to generate the graph of the motion vectors, the instructions cause the at least one processor to: generate a feature graph based on the features the first image and the second image, the feature graph including nodes connected by edges, and wherein the nodes of the graph include features; and place motion features into nodes of the graph, wherein the motion features are based on the motion vectors.

Aspect 28. The non-transitory computer-readable medium of Aspect 27, wherein placing motion features in the nodes of the graph comprises replacing the features of the nodes with motion features.

Aspect 29. The non-transitory computer-readable medium of Aspect 24, wherein the location of the graph cut is determined based on a set of differentiable linear equations.

Aspect 30. The non-transitory computer-readable medium of any of Aspects 22-29, wherein the motion vectors are generated based on a similarity between features of the first image and neighboring portions of the features in the second image.

Aspect 31: An apparatus for image generation, comprising means for performing one or more of operations according to any of Aspects 1 to 11.

1. A method for image processing, comprising:
obtaining, from one or more image sensors, a first image and a second image;
determining local motion between the first image and the second image for features of the first image and the second image;
generating motion vectors based on the local motion; and
identifying an object based on the motion vectors.

2. The method of claim 1, further comprising processing the object to generate a prediction for output.

3. The method of claim 1, further comprising:
generating a graph of the motion vectors; and
determining a location of a graph cut to the graph of motion vectors based on the motion vectors.

4. The method of claim 3, wherein the location of the graph cut is based on differences between the motion vectors.

5-11. (canceled)

12. An apparatus for image processing, comprising:
at least one memory; and
at least one processor coupled to the at least one memory and configured to:
obtain, from one or more image sensors, a first image and a second image;
determine local motion between the first image and the second image for features of the first image and the second image;
generate motion vectors based on the local motion; and
identify an object based on the motion vectors.

13. The apparatus of claim 12, wherein the at least one processor is further configured to process the object to generate a prediction for output.

14. The apparatus of claim 12, wherein the at least one processor is further configured to:
generate a graph of the motion vectors; and
determine a location of a graph cut to the graph of motion vectors based on the motion vectors.

15. The apparatus of claim 14, wherein the location of the graph cut is based on differences between the motion vectors.

16. The apparatus of claim 14, wherein the graph cut is between a source node and a terminal node of the graph.

17. The apparatus of claim 14, wherein, to generate the graph of the motion vectors, the at least one processor is configured to:
generate a feature graph based on the features of the first image and the second image, the feature graph including nodes connected by edges, and wherein the nodes of the graph include features; and
place motion features into nodes of the graph, wherein the motion features are based on the motion vectors.

18. The apparatus of claim 17, wherein placing motion features in the nodes of the graph comprises replacing the features of the nodes with motion features.

19. The apparatus of claim 14, wherein the location of the graph cut is determined based on a set of differentiable linear equations.

20. The apparatus of claim 12, wherein the motion vectors are generated based on a similarity between features of the first image and neighboring portions of the features in the second image.

21. The apparatus of claim 12, wherein features comprises one or more pixels of the first image and the second image.

22. A non-transitory computer-readable medium having stored thereon instructions that, when executed by at least one processor, cause the at least one processor to:
obtain, from one or more image sensors, a first image and a second image;
determine local motion between the first image and the second image for features of the first image and the second image;
generate motion vectors based on the local motion; and
identify an object based on the motion vectors.

23-30. (canceled)
